(19) United States
(12) Patent Application Publication
(10) Pub. No.: US 2009/0019714 A1
(43) Pub. Date: Jan. 22, 2009

(54) Balance Unit with Direction-Setting Function

(76) Inventors: Tzu-Ying Wu, Taipei City (TW); Reui-Hua Hung, Banqiao City (TW)

Correspondence Address: Alan Kamrath;Mamrath & Associates, P.A., Suite 245, 4825 Olson Memorial Highway, Golden Valley, MN, 55422, US

(21) Appl. No.: 11/778,861

(22) Filed: Jul. 17, 2007

(51) Int. Cl. G01C 17/02

(52) U.S. Cl. 33/355 R

(57) ABSTRACT

A balance unit with direction-setting function, including a support element positioned on a preset locating face, the support element having a contact section; a balance element having a contact section at its gravity center for contacting with the contact section of the support element by very little frictional coefficient, the balance element having a direction-indicating section; and a magnetic element connected with the balance element. By means of the interaction between the magnetic element and terrestrial magnetism, the balance element can overcome the little frictional force between the balance element and the support element, whereby the direction-indicating section of the balance element can naturally move to indicate a preset direction.

### BACKGROUND OF THE INVENTION

The present invention is related to a balance unit with direction-setting function, and more particularly to a balance unit designed with decorative pattern and capable of indicating a preset direction.

A conventional balance unit with direction-indicating function (such as a compass) generally has a housing (container). An internal receiving space is defined in the housing and isolated from outer side. A thin and lightweight magnetic strip is arranged in the receiving space. A middle section of the magnetic strip is supported on a post (seat). By means of the interaction between the magnetic strip and terrestrial magnetism, two ends of the magnetic strip naturally are respectively directed to the north and the south of the earth.

However, the above balance unit generally lacks pattern design and decorative effect. Basically, only the housing of the balance unit has some changes and the magnetic strip is still monotonously arranged in the receiving space of the housing without any other function. Therefore, such product can hardly attract consumers. It is therefore tried by the applicant to provide a balance unit with funny and decorative structure and appearance.

### SUMMARY OF THE INVENTION

It is therefore a primary object of the present invention to provide a balance unit with direction-setting function. The balance unit can be used to indicate a preset direction for a user to easily identify the direction.

It is a further object of the present invention to provide the above balance unit permitting a user to preset a specific direction in which an indicating section is naturally directed. Therefore, the application range of the balance unit is widened.

It is still a further object of the present invention to provide the above balance unit with direction-setting function, which is designed with decorative pattern to achieve a decorative effect.

According to the above objects, the balance unit with direction-setting function of the present invention includes: a support element connectable/fixable on a preset locating face, the support element having a contact section; a balance element having a direction-indicating section and a contact section at its gravity center for contacting with the contact section of the support element by very little friction; and a magnetic element connected with the balance element in a preset direction. By means of the interaction between the magnetic element and terrestrial magnetism, the direction-indicating section of the balance element can naturally move to indicate a preset direction.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a perspective assembled view of the first embodiment of the present invention;

FIG. 2A is a perspective view according to FIG. 2, in which the magnetic elements are positioned in different positions;

FIG. 3 is a side assembled view of the first embodiment of the present invention;

FIG. 3A is an enlarged view of the circled area A of FIG. 3;

FIG. 4 is a perspective view of the first embodiment of the present invention, showing the balancing operation thereof;

FIG. 5 is a perspective assembled view of a second embodiment of the present invention;

FIG. 6 is a perspective assembled view of a third embodiment of the present invention;

FIG. 7 is a perspective view of a fourth embodiment of the present invention in one state;

FIG. 8 is a perspective view of the fourth embodiment of the present invention in another state;

FIG. 9 shows a fifth embodiment of the present invention;

FIG. 10 shows a sixth embodiment of the present invention;

FIG. 11 is a perspective view of a seventh embodiment of the present invention;

FIG. 11A is a perspective exploded view according to FIG. 11;

FIG. 12 is a side view according to FIG. 11, showing the operation of the seventh embodiment of the present invention;

FIG. 13 is a perspective view of an eighth embodiment of the present invention; and

FIG. 13A is a sectional view according to FIG. 13, showing the structure of the eighth embodiment of the present invention.

### DETAILED DESCRIPTION OF THE PREFERRED EMBODIMENTS

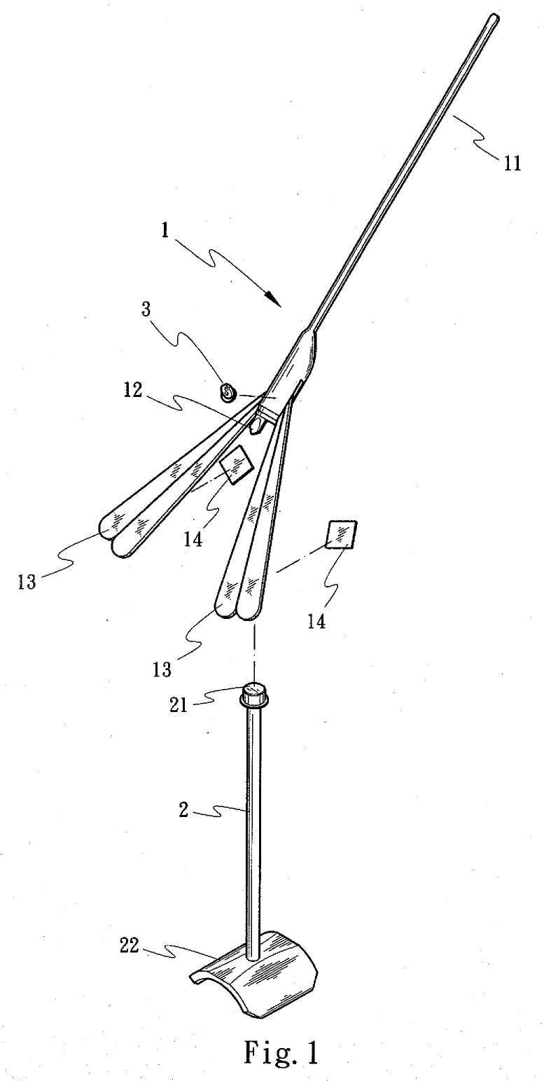

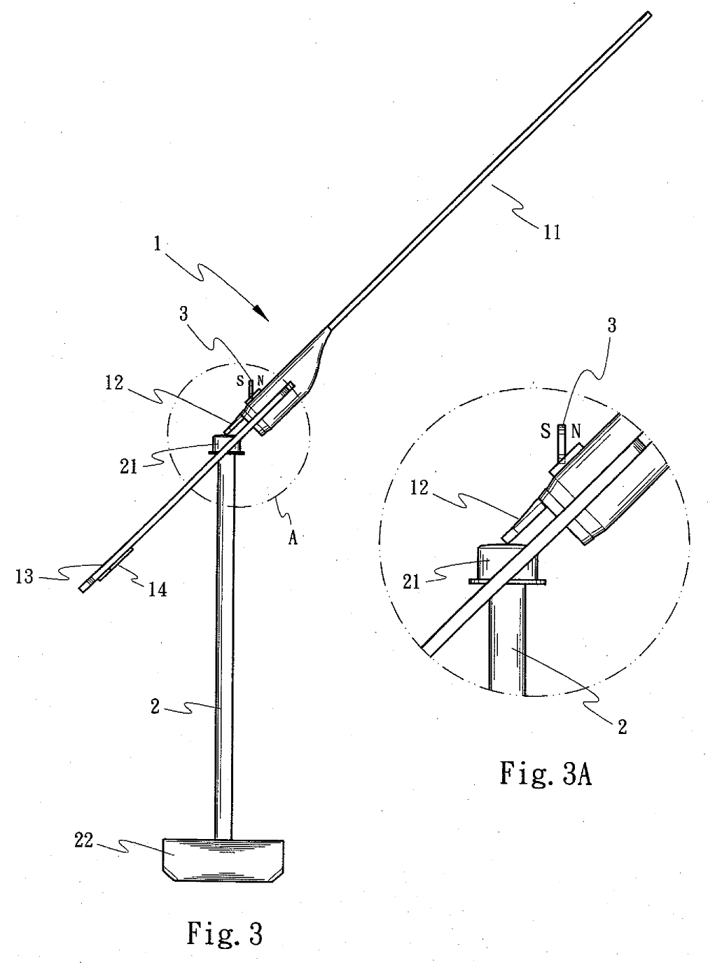

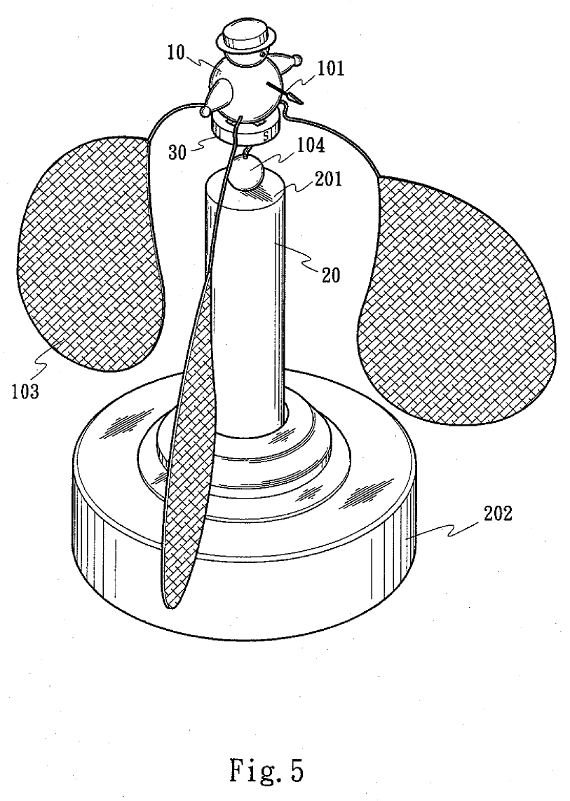

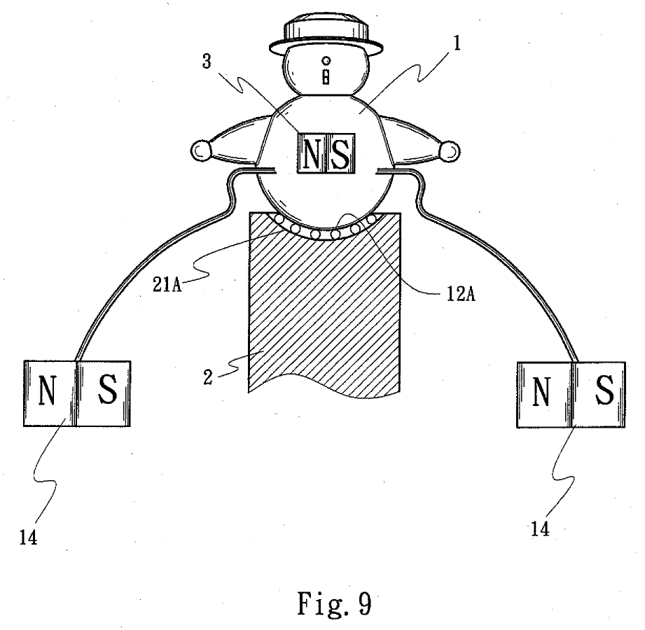

Please refer to FIGS. 1 to 3A. According to a first embodiment, the balance unit of the present invention includes a balance element 1, a support element 2 (which is a post or a column in FIGS. 1 to 5) and a magnetic element 3. One end of the support element 2 is formed with a seat section 22 which is stably rested on a rest face such as a table face or a ground. Alternatively, the balance unit of the present invention can include a hanging element 23 for hanging the balance unit. The other end of the support element 2 is formed with a contact section 21 which can be a contact face with very little friction. The balance element 1 can be designed with a certain pattern such as a doll, an animal, a plant, a grass, a flower, a mountain or the like. Therefore, basically, the balance element 1 has a decorative and beautifying function. The balance element 1 has an indicating section 11 for indicating a set direction. The indicating section 11 can be an indicating point or an indicating projection. The gravity center of the balance element 1 is formed with a contact section 12 corresponding to the contact section 21 of the support element 2. The two contact sections 12, 21 contact with each other by little frictional force, whereby the balance element 1 is naturally balanced. The contact sections 12, 21 contact with each other at a point of very small area (as shown in FIGS. 3 and 5). Alternatively, as shown in FIG. 9, several ball fulcrums 12A are positioned between the balance element 1 and a spherical recessed seat 21A by extremely low frictional coefficient. In addition, at least one weight 14 can be disposed beside the gravity center of the balance element 1, for example, on a wing section 13. Accordingly, the balance element 1 can be held in a predetermined asymmetrical (inclined) balanced state. At least one magnetic element 3 is combined with the balance element 1. Alternatively, the balance element 1 can be directly made of a magnetic material. The magnetic element 3 can be mounted on a surface of the balance element 1. Alternatively, the magnetic element 3 can be accommodated in the balance element 1.

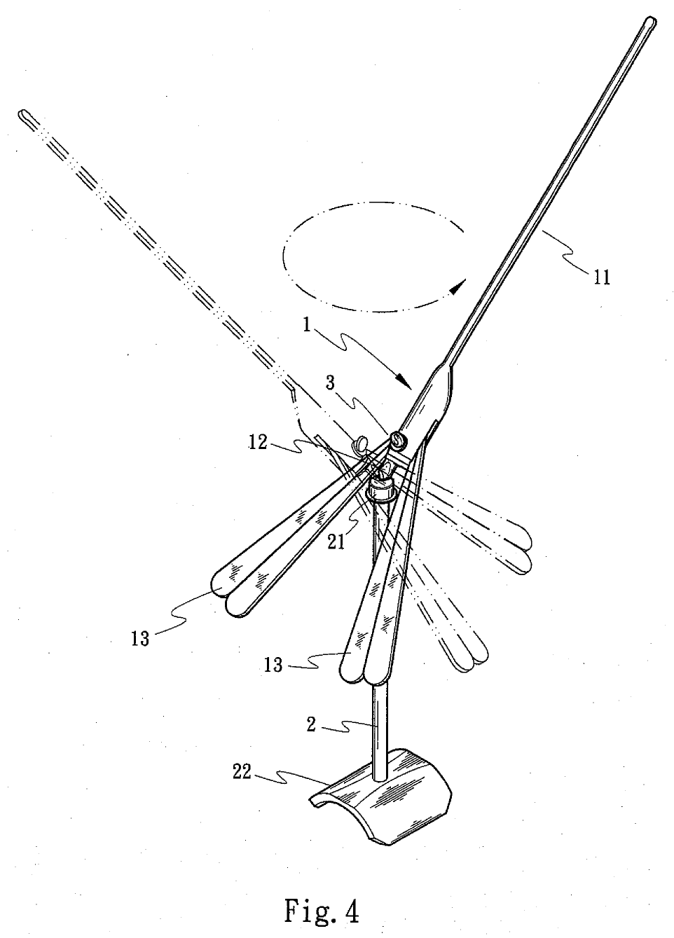

FIG. 4 shows the balancing operation of the first embodiment of the present invention. By means of the interaction force between the magnetic element 3 and the terrestrial magnetism, the balance element 1 is held in a certain direction. In a natural balanced state, the indicating section 11 of the balance element 1 is always restored from an unset direction into a fixed direction on the balance of the magnetic element 3 and the terrestrial magnetism. Alternatively, the indicating section 11 can be directed north, south, east, west, east south, east north, west south, west north or in any other preset direction. Therefore, the indicated direction of the balance unit of the present invention is presettable.

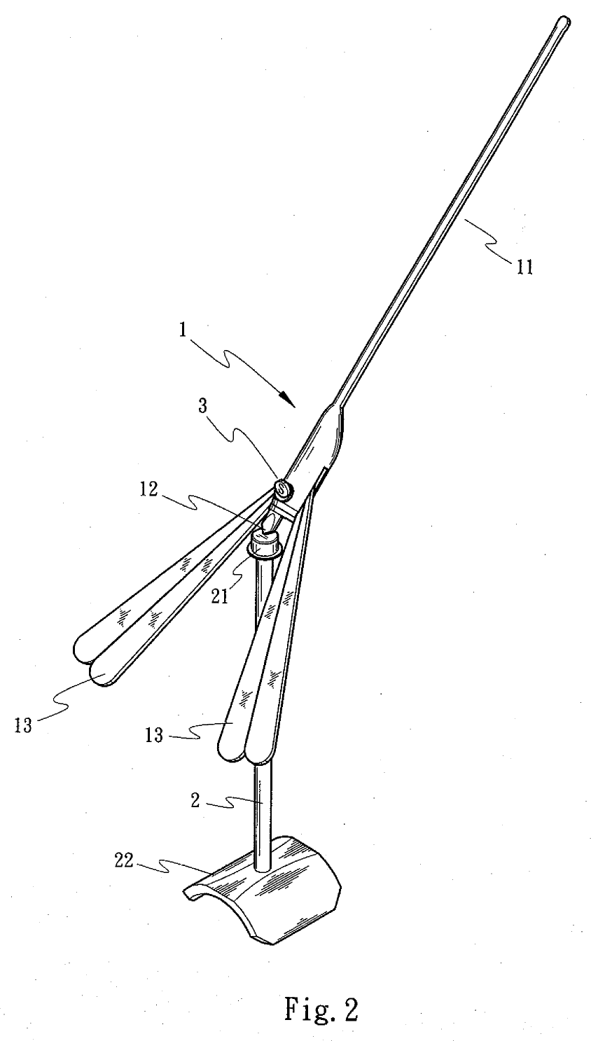

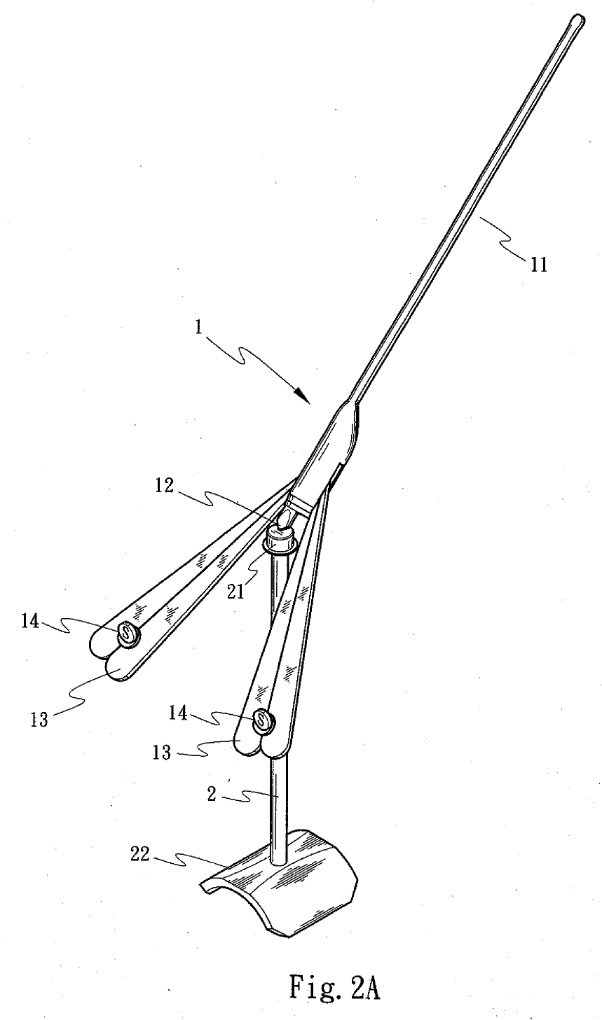

In practice, the weight 14 can be magnetic. Alternatively, the weights 14 can directly serve as the magnetic elements arranged in the same magnetic direction (as shown in FIGS. 2A and 9). Accordingly, the magnetic weights 14 can directly act on the balance element 1 to indicate the set direction.

Moreover, a user can use an external magnetic body to get close to the balance element 1 and the magnetic element 3. By means of the interaction between the magnetism of the external magnetic body and the magnetic element 3, the balanced state of the balance element 11 will be affected. Under such circumstance, the indicating section 11 of the balance element 1 is driven to change the direction or even rotate or slide in a predetermined path. This can achieve an entertaining effect.

FIG. 5 shows a second embodiment of the present invention, in which the support element 20 is a column having a seat section 202 at the bottom. A top end of the support element 20 contacts a bottom end of the balance element 10 at a point of very small area. FIG. 5 shows that a spherical surface of a ball body 104 contacts a top end face 201 of the support element 20. The balance element 10 can be a doll or any other decorative body. Several wing-like weights 103 and a direction-indicating section 101 outward extend from the balance element 10. A plate-shaped magnetic element 30 is connected with bottom side of the balance element 10. The magnetic element 30 is positioned on a fulcrum to contact therewith by little friction. Similarly, by means of the interaction force between the magnetic element 30 and the terrestrial magnetism, in a naturally balanced state, the indicating section 101 of the balance element 10 is directed in a preset direction.

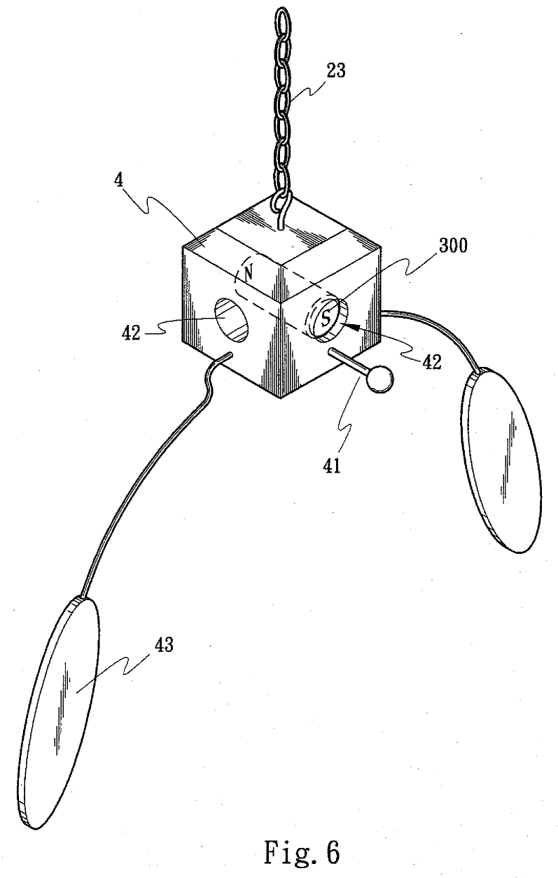

FIG. 6 is a perspective view showing a third embodiment of the present invention, in which several plate-shaped weights 43 and at least one direction-indicating section 41 outward extend from the balance element 4. A hanging-type support element 23 (such as a fine chain or a cord) is connected with the top of the balance element 4, whereby the balance element 4 is suspended in the air. The balance element 4 is formed with several cavities or receiving spaces 42 in which magnetic elements 300 can be inlaid. Via the hanging-type support element 23, the balance element 4 is suspended in the air with very little loss of energy when rotated. By means of the interaction force between the magnetic element 300 and the terrestrial magnetism, in a naturally balanced state, the indicating section 41 of the balance element 4 is directed in a preset direction.

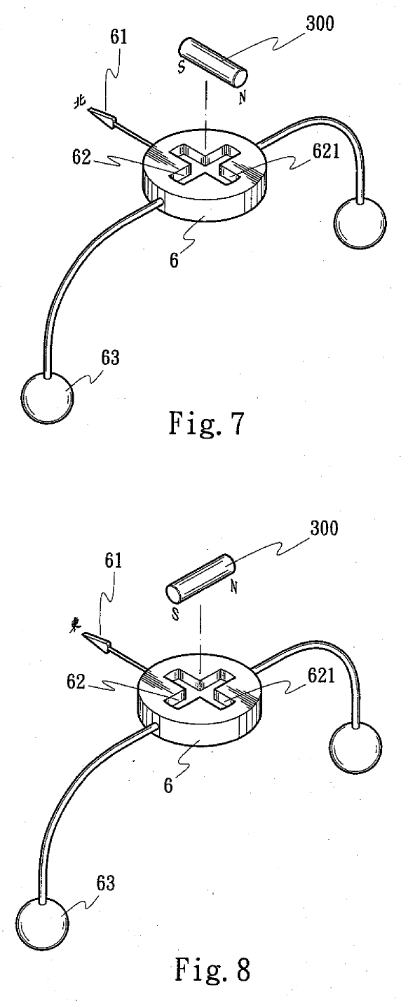

FIGS. 7 and 8 show a fourth embodiment of the present invention, in which the magnetic element 300 can be installed in the balance element 6. A fulcrum (not shown) with very little loss of energy is disposed under the bottom of the balance element 6. Several weights 63 and at least one direction-indicating section 61 outward extend from the balance element 6. In addition, a surface of the balance element 6 is formed with multiple receptacles 62, 621, whereby the magnetic element 300 can be selectively accommodated in any of the receptacles 62, 621. Accordingly, the indicating section 61 of the balance element 6 can be directed in different directions as desired. This widens the application range and enhances the entertaining effect.

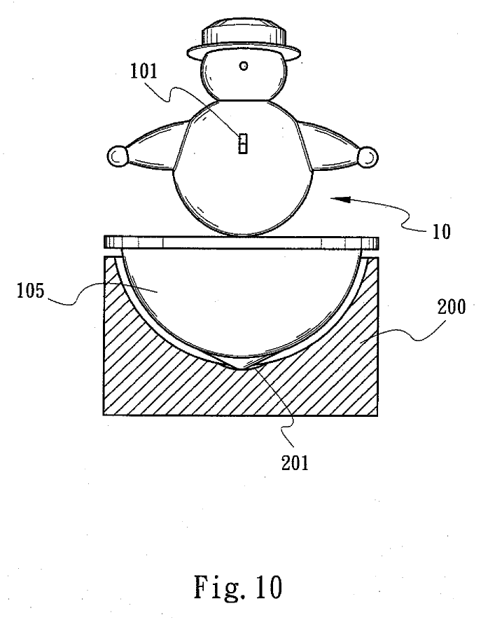

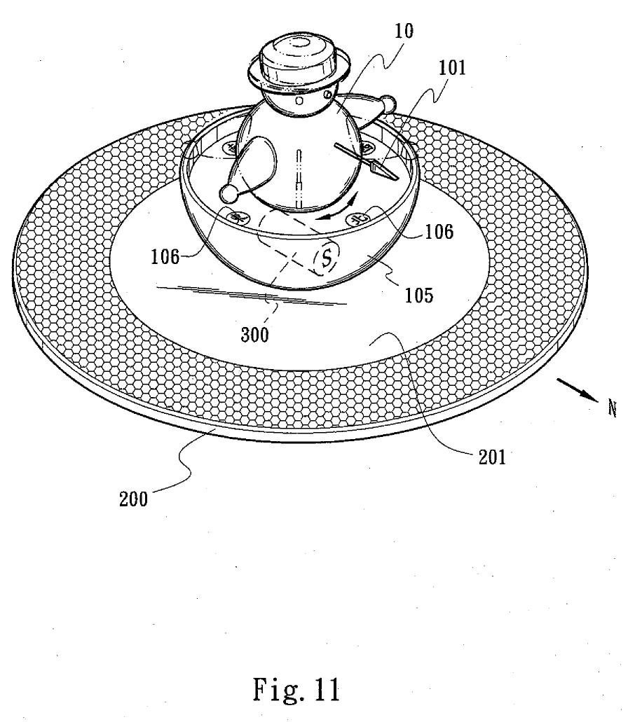

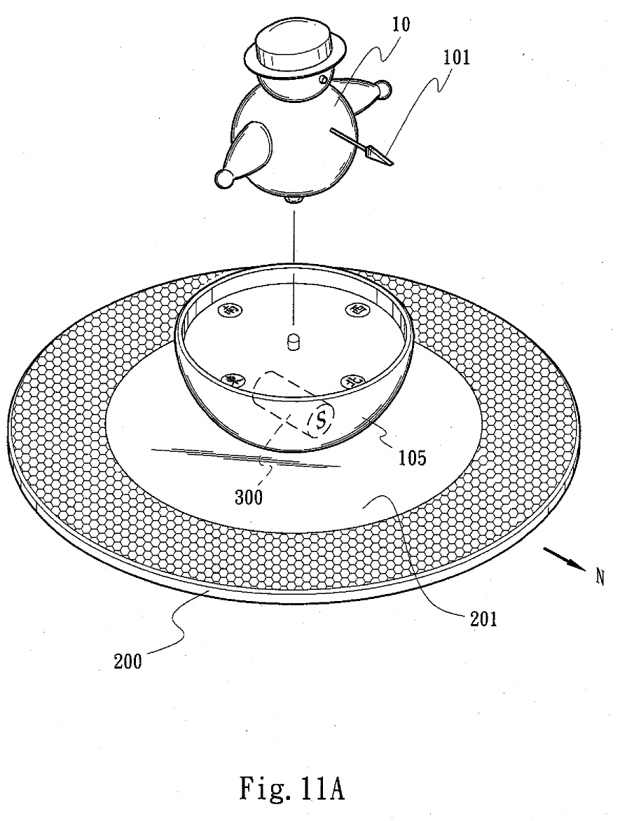

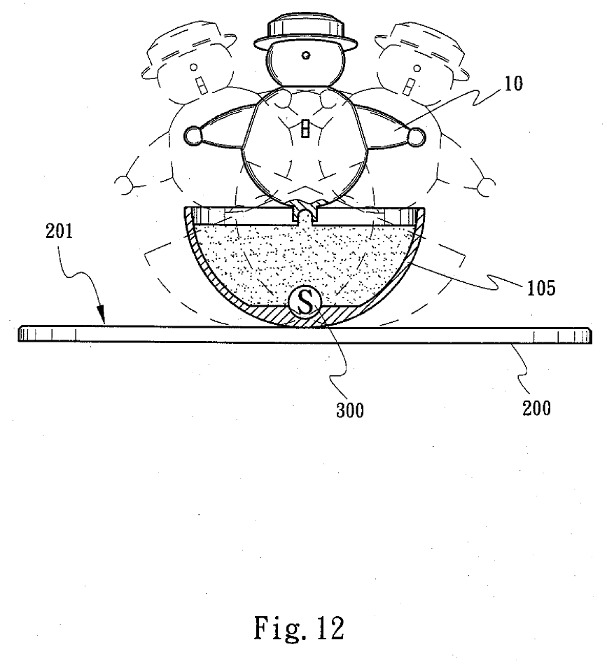

Please refer to FIGS. 10 to 12. A base seat 105 serving as a weight is disposed under the balance element 10. The base seat 105 has a convex face and a magnetic element 300 is mounted in the balance element 10. The bottom end of the base seat 105 is rested on a fulcrum 201 of a smooth concave support element 200 (FIG. 10) or plane support element 200 (FIG. 11) by low friction. The balance element 10 is separable from the base seat weight 105 or integrally connected therewith as necessary. In the case that the balance element 10 is separable from the base seat weight 105, a user can replace the balance element 10 with another to change the pattern and achieve more funniness. Moreover, the base seat weight 105 can be marked with direction indexes 106. Accordingly, when the balance element 10 is rotated on the base seat 105, the balance element 10 can indicate the direction as shown by the phantom line of FIG. 11.

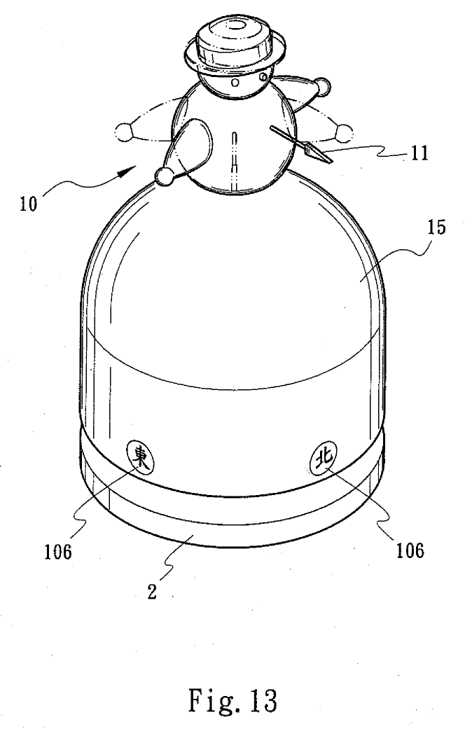

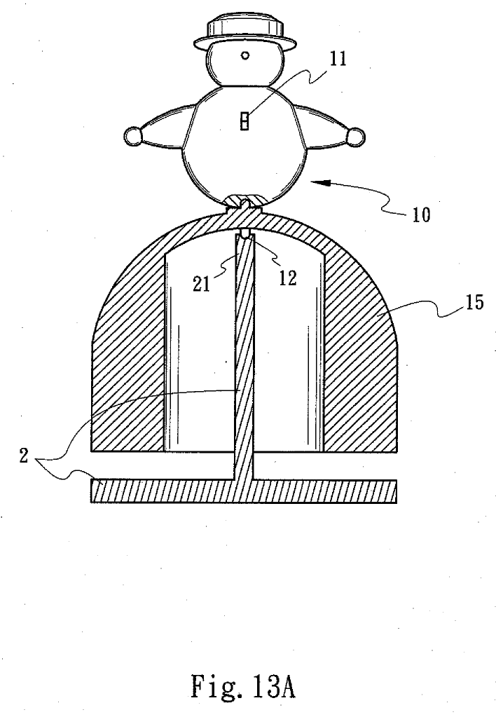

Referring to FIGS. 13, and 13A, the support element 2 can be connected with the balance element 1. In addition, the bottom of the balance element 1 can be formed with a skirt section 15. A contact section 12 can be formed on inner face of the top of the skirt section 15 corresponding to the contact section 21 of the support element 2. Accordingly, the contact points of the two contact sections 12, 21 are shaded and hidden in the skirt section 15. In addition, the skirt section 15 serves as a stable weight lower than the contact points. This can achieve a best stabilizing and balancing effect.

According to the above arrangement, the balance unit with direction-setting function of the present invention can achieve a direction-indicating effect as well as a beautifying/decorative effect.

The above embodiments are only used to illustrate the present invention, not intended to limit the scope thereof. Many modifications of the above embodiments can be made without departing from the spirit of the present invention.

What is claimed is:

1. A balance unit with direction-setting function, comprising:
a support element connectable/fixable on a preset locating face;
a balance element contacting the support element with very little loss of energy when rotated, whereby the balance element contacts with the support element in a naturally balanced state; and
a magnetic element connected with the balance element, whereby by means of the interaction force between the magnetic element and terrestrial magnetism, the balance element is driven and rotated about the support element to indicate a preset direction.

2. The balance unit with direction-setting function as claimed in claim 1, wherein the support element and the balance element respectively have contact sections in contact with each other by very little frictional force.

3. The balance unit with direction-setting function as claimed in claim 2, wherein the contact section of the balance element is formed with a contact point of very small area.

4. The balance unit with direction-setting function as claimed in claim 2, wherein the contact section of the support element is formed with a contact point of very small area.

5. The balance unit with direction-setting function as claimed in claim 2, wherein the support element and the balance element contact each other via several ball fulcrums and a spherical recessed seat.

6. The balance unit with direction-setting function as claimed in claim 2, wherein a base seat serving as a weight is disposed under the balance element, the base seat having a convex face.

7. The balance unit with direction-setting function as claimed in claim 6, wherein the base seat of the balance element is rested on a plane face of the support element.

8. The balance unit with direction-setting function as claimed in claim 6, wherein the base seat of the balance element is rested on a concave face of the support element.

9. The balance unit with direction-setting function as claimed in claim 1, wherein the support element is a rigid support body.

10. The balance unit with direction-setting function as claimed in claim 2, wherein the support element is a rigid support body.

11. The balance unit with direction-setting function as claimed in claim 9, wherein the support element is a rigid post.

12. The balance unit with direction-setting function as claimed in claim 9, wherein the support element is a rigid column.

13. The balance unit with direction-setting function as claimed in claim 1, wherein a bottom of the balance element is formed with a skirt section, a contact section being formed on inner face of a top end of the skirt section corresponding to the contact section of the support element, whereby the contact section of the balance element is supported on the contact section of the support element.

14. The balance unit with direction-setting function as claimed in claim 2, wherein a bottom of the balance element is formed with a skirt section, a contact section being formed on inner face of a top end of the skirt section corresponding to the contact section of the support element, whereby the contact section of the balance element is supported on the contact section of the support element.

15. The balance unit with direction-setting function as claimed in claim 1, wherein the support element is a hanging-type support element.

16. The balance unit with direction-setting function as claimed in claim 2, wherein the support element is a hanging-type support element.

17. The balance unit with direction-setting function as claimed in claim 1, wherein the balance element is formed with multiple receptacles in which the magnetic element can be snugly accommodated, the receptacles being arranged in different directions.

18. The balance unit with direction-setting function as claimed in claim 2, wherein the balance element is formed with multiple receptacles in which the magnetic element can be snugly accommodated, the receptacles being arranged in different directions.

19. The balance unit with direction-setting function as claimed in claim 13, wherein the balance element is formed with multiple receptacles in which the magnetic element can be snugly accommodated, the receptacles being arranged in different directions.

20. The balance unit with direction-setting function as claimed in claim 15, wherein the balance element is formed with multiple receptacles in which the magnetic element can be snugly accommodated, the receptacles being arranged in different directions.

21. The balance unit with direction-setting function as claimed in claim 1, wherein at least one weight is disposed beside the gravity center of the balance element, whereby the balance element can be held on the support element in an asymmetrical balanced state.

22. The balance unit with direction-setting function as claimed in claim 2, wherein at least one weight is disposed beside the gravity center of the balance element, whereby the balance element can be held on the support element in an asymmetrical balanced state.

23. The balance unit with direction-setting function as claimed in claim 13, wherein at least one weight is disposed beside the gravity center of the balance element, whereby the balance element can be held on the support element in an asymmetrical balanced state.

24. The balance unit with direction-setting function as claimed in claim 15, wherein at least one weight is disposed beside the gravity center of the balance element, whereby the balance element can be held on the support element in an asymmetrical balanced state.

25. The balance unit with direction-setting function as claimed in claim 17, wherein at least one weight is disposed beside the gravity center of the balance element, whereby the balance element can be held on the support element in an asymmetrical balanced state.

26. The balance unit with direction-setting function as claimed in claim 21, wherein the weight is magnetic.

27. The balance unit with direction-setting function as claimed in claim 1, wherein the balance element itself is a magnetic body.

28. The balance unit with direction-setting function as claimed in claim 2, wherein the balance element itself is a magnetic body.

29. The balance unit with direction-setting function as claimed in claim 1, wherein the balance element has a direction-indicating section.

30. The balance unit with direction-setting function as claimed in claim 2, wherein the balance element has a direction-indicating section.

31. The balance unit with direction-setting function as claimed in claim 13, wherein the balance element has a direction-indicating section.

32. The balance unit with direction-setting function as claimed in claim 15, wherein the balance element has a direction-indicating section.

33. The balance unit with direction-setting function as claimed in claim 17, wherein the balance element has a direction-indicating section.

34. The balance unit with direction-setting function as claimed in claim 21, wherein the balance element has a direction-indicating section.

35. The balance unit with direction-setting function as claimed in claim 26, wherein the balance element has a direction-indicating section.

36. The balance unit with direction-setting function as claimed in claim 27, wherein the balance element has a direction-indicating section.
